(19) United States
(12) Patent Application Publication
(10) Pub. No.: US 2024/0089170 A1
(43) Pub. Date: Mar. 14, 2024

(54) ON-BOARD APPARATUS, METHOD FOR CONTROLLING COMMUNICATION SPEED, AND PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Akira MIYAJO, Yokkaichi-shi, Mie (JP); Yuanjun XIAN, Yokkaichi-shi, Mie (JP)

(21) Appl. No.: 18/263,815

(22) PCT Filed: Jan. 17, 2022
(86) PCT No.: PCT/JP2022/001372

§ 371 Date: Aug. 1, 2023

(30) Foreign Application Priority Data
Feb. 2, 2021 (JP) 2021-015233

(51) Int. Cl. H04L 41/0816; H04L 41/0896; H04W 4/48

(52) U.S. Cl. CPC H04L 41/0816; H04L 41/0896; H04W 4/48

(57) ABSTRACT

Provided is an on-board apparatus that is connected to an on-board device and communicates with the on-board device, and includes a control unit configured to control communication with the on-board device, and a communication line for communicating with the on-board device, and the control unit communicates with the on-board device via the communication line, detects a communication load on the communication line, and controls a communication speed of communication that is performed via the communication line, based on the detected communication load.

### CROSS-REFERENCE TO RELATED APPLICATIONS

This application is the U.S. national stage of PCT/JP2022/001372 filed on Jan. 17, 2022, which claims priority of Japanese Patent Application No. JP 2021-015233 filed on Feb. 2, 2021, the contents of which are incorporated herein.

### TECHNICAL FIELD

The present disclosure relates to an on-board apparatus, a method for controlling a communication speed, and a program.

### BACKGROUND

A plurality of on-board devices that include powertrain apparatuses for engine control and the like, body apparatuses for air-conditioner control and the like, and a plurality of on-board ECUs (Electronic Control Units) for controlling such on-board apparatuses are mounted in a vehicle. The plurality of on-board devices are connected to an on-board apparatus. The on-board apparatus communicates with the on-board devices (for example, JP 2017-47835A).

Communication is also performed in the on-board apparatus of JP 2017-47835A, but the frequency and the communication speed of such communication have increased due to the advancement of vehicles. There is concern that power consumption of the on-board apparatus will increase due to an increase in the frequency and communication speed of the above communication.

The present disclosure has been made in view of the aforementioned circumstances, and an object thereof is to provide an on-board apparatus and the like that can suppress an increase in power consumption.

### SUMMARY

An on-board apparatus according to an aspect of the present disclosure is an on-board apparatus that is connected to an on-board device and communicates with the on-board device, and includes: a control unit configured to control communication with the on-board device, and a communication line for communicating with the on-board device, and the control unit communicates with the on-board device via the communication line, detects a communication load on the communication line, and controls a communication speed of communication that is performed via the communication line, based on the detected communication load.

### Advantageous Effects

According to an aspect of the present disclosure, it is possible to suppress an increase in power consumption.

### BRIEF DESCRIPTION OF THE DRAWINGS

FIG. 1 is a schematic diagram illustrating a configuration of an on-board system according to a first embodiment.

FIG. 2 is a diagram for describing the relation between a communication load-threshold value relation, communication speed, and generation of standard.

FIG. 3 is a flowchart illustrating processing that is performed by a control unit of a processing unit.

FIG. 4 is a conceptual diagram showing a content example of a communication speed table.

FIG. 5 is a flowchart illustrating processing that is performed by a control unit according to a second embodiment.

FIG. 6 is a flowchart illustrating processing that is performed by a control unit according to a third embodiment.

FIG. 7 is a schematic diagram illustrating a configuration of an on-board system according to a fourth embodiment.

### DETAILED DESCRIPTION OF PREFERRED EMBODIMENTS

First, embodiments of the present disclosure will be listed and described. In addition, at least some of the embodiments described below may be combined as appropriate.

An on-board apparatus according to an aspect of the present disclosure is an on-board apparatus that is connected to an on-board device and communicates with the on-board device, and includes: a control unit configured to control communication with the on-board device, and a communication line for communicating with the on-board device, and the control unit communicates with the on-board device via the communication line, detects a communication load on the communication line, and controls a communication speed of communication that is performed via the communication line, based on the detected communication load.

In this aspect, the control unit communicates with the on-board device via the communication line. The control unit detects a communication load on the communication line, and controls the communication speed of communication based on the detected communication load. If, for example, the communication load is larger than or equal to a fixed value, the control unit increases the communication speed. If the communication load is smaller than the fixed value, the control unit decreases the communication speed. Generally, power consumption when the communication speed is high is large. Power consumption when the communication speed is low is small. Communication is performed at a communication speed that is based on a communication load, and thus it is possible to suppress an increase in the power consumption of the on-board apparatus.

In the on-board apparatus according to an aspect of the present disclosure, the control unit increases the communication speed when the communication load increases, and decreases the communication speed when the communication load decreases.

In this aspect, the control unit increases the communication speed when the communication load increases. In addition, the control unit decreases the communication speed when the communication load decreases. The control unit can efficiently control the communication speed in accordance with the communication load.

In the on-board apparatus according to an aspect of the present disclosure, the control unit controls the communication speed by increasing/decreasing a bandwidth that is used for communication on the communication line.

In this aspect, a communication speed that is based on a bandwidth used for communication is stipulated for the communication line. The control unit controls the communication speed by increasing/decreasing the bandwidth used for communication, and thus the communication speed is easily changed.

In the on-board apparatus according to an aspect of the present disclosure, the bandwidth that is used for communication on the communication line includes bandwidths of a plurality of generations that are compatible with each other based on a standard of communication, and the control unit increases/decreases the bandwidth that is used for communication on the communication line, by switching to one bandwidth out of the bandwidths of the plurality of generations based on the detected communication load.

In this aspect, the bandwidth that is used for communication on the communication line includes bandwidths of a plurality of generations that are compatible with each other based on a standard of communication, and thus, it is possible to switch to a bandwidth of an appropriate generation that is based on the communication load using the compatibility of the standard between generations (downward compatibility), and efficiently control the communication speed.

The on-board apparatus according to an aspect of the present disclosure includes a plurality of communication lines, and the control unit controls the communication speed by increasing/decreasing the number of communication lines that are used for communication.

In this aspect, the control unit can communicate with the on-board device via a plurality of communication lines. The control unit controls the communication speed by increasing/decreasing the number of communication lines that are used for communication. The control unit can perform communication at a higher communication speed by using a plurality of communication lines than a communication speed when one communication line is used.

In the on-board apparatus according to an aspect of the present disclosure, the control unit obtains a temperature of the on-board apparatus, and decreases the communication speed if the obtained temperature is higher than or equal to a predetermined temperature.

In this aspect, the control unit obtains the temperature of the on-board apparatus. If the obtained temperature is higher than or equal to the predetermined temperature, the control unit decreases the communication speed, and thus the amount of heat generation in the on-board apparatus decreases compared with the amount of heat generation before the communication speed was decreased. It is possible to prevent the temperature of the on-board apparatus from becoming too high by decreasing the amount of heat generation. The temperature of the on-board apparatus does not become too high, and thus it is possible to prevent the on-board apparatus from malfunctioning due to a high temperature.

In the on-board apparatus according to an aspect of the present disclosure, the control unit controls the communication speed based on the detected communication load and a communication speed table in which a plurality of communication loads and a plurality of communication speeds are stored in association with each other.

In this aspect, the communication speed table stores a plurality of communication loads and a plurality of communication speeds in association with each other. The control unit controls the communication speed based on the communication speed table and the detected communication load, and thus, even when a plurality of communication speeds can be selected, it is possible to appropriately set a communication speed that is based on the communication load.

The on-board apparatus according to an aspect of the present disclosure includes a relay device that relays communication between the control unit and the on-board device, the communication line includes a first communication line that connects the control unit and the relay device and a second communication line that connects a wireless communication unit for performing wireless communication and the relay device, the control unit communicates with the on-board device via the first communication line and the relay device, and controls the communication speed of communication that is performed via the first communication line, based on the communication load on the first communication line, and the relay device communicates with the wireless communication unit via the second communication line, and controls the communication speed of communication that is performed via the second communication line, based on the communication load on the second communication line.

In this aspect, the control unit is connected to the relay device by the first communication line. The control unit communicates with the on-board device via the first communication line and the relay device. The control unit controls the communication speed of communication that is performed via the first communication line, based on the communication load on the first communication line. The relay device is connected to the wireless communication unit by the second communication line. The wireless communication unit performs wireless communication with an external server provided outside the vehicle or a mobile terminal held by an occupant of the vehicle, for example. The relay device controls the communication speed of communication that is performed via the second communication line, based on the communication load on the second communication line. When, for example, a large amount of data such as an update program for the on-board device obtained from the external server is transmitted from the wireless communication unit, the relay device can receive the above large amount of data at a high communication speed. The communication speeds on the first communication line and the second communication line are controlled based on the communication loads, and thus it is possible to effectively suppress an increase in power consumption of the on-board apparatus.

A method for controlling a communication speed according to an aspect of the present disclosure is a method for controlling a communication speed that is performed by an on-board apparatus that is connected to an on-board device and communicates with the on-board device, and the on-board apparatus communicates with the on-board device via a communication line for communicating with the on-board device, detects a communication load on the communication line, and controls a communication speed based on the detected communication load.

In this aspect, similarly to aspect (1), it is possible to suppress an increase in power consumption.

A program according to an aspect of the present disclosure causes a computer that is connected to an on-board device and communicates with the on-board device to execute processing for communicating with the on-board device via a communication line for communicating with the on-board device, detecting a communication load on the communication line, and controlling a communication speed based on the detected communication load.

In this aspect, it is possible to cause a computer to function as the on-board apparatus according to an aspect of the present disclosure.

### DETAILED EMBODIMENTS OF PRESENT DISCLOSURE

The present disclosure will be described in detail with reference to the drawings illustrating embodiments of the present disclosure. An on-board apparatus according to an embodiment of the present disclosure will be described below with reference to the drawings. Note that the present disclosure is not limited to these examples, but is defined by the claims and intended to include all modifications within the meaning and scope equivalent to the claims.

### First Embodiment

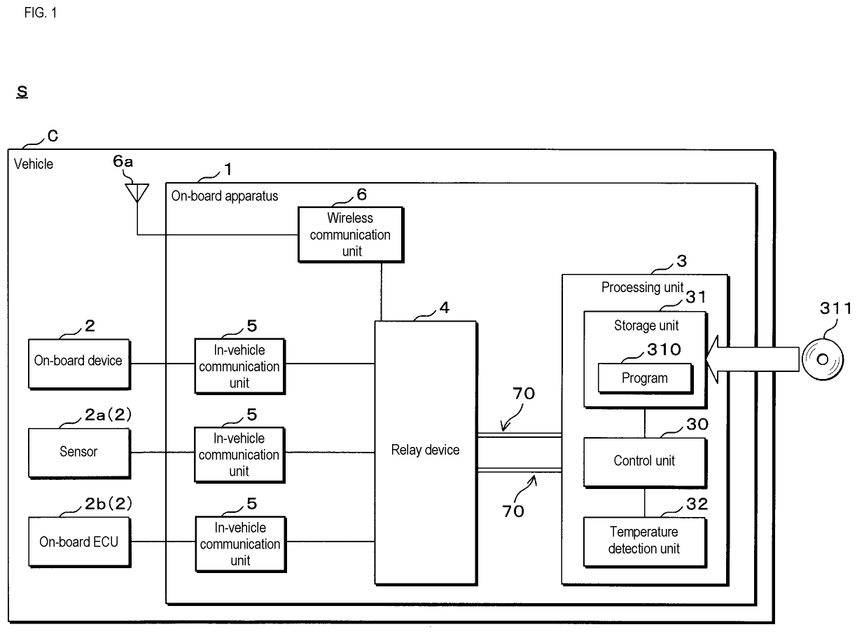

An embodiment will be described below with reference to the drawings. FIG. 1 is a schematic diagram illustrating a configuration of an on-board system S according to a first embodiment. The on-board system S includes an on-board apparatus 1 that is mounted in a vehicle C. A plurality of on-board devices 2 that are mounted in the vehicle C are connected to the on-board apparatus 1.

Examples of the on-board devices 2 include various sensors 2a that include a LiDAR (Light Detection and Ranging) sensor, a light sensor, a CMOS camera, and an infrared sensor, and an on-board ECU (Electronic Control Unit) 2b. The on-board devices 2 are not limited to the above examples, and may include a door opening/closing apparatus, and an actuator such as a motor apparatus, may include switches such as a door SW (switch) and a lamp SW, or may include a lamp. Three on-board devices 2 are mounted in the vehicle C in FIG. 1, but the number of on-board devices 2 is not limited to three.

The on-board apparatus 1 is a relay apparatus such as a gateway or an Etherswitch that relays communication between the plurality of on-board devices 2. The on-board apparatus 1 performs communication with the on-board devices 2. In the present embodiment, an example will be described in which the Ethernet (Ethernet/registered trademark) communication protocol is used for communication, but the communication protocol that is used for communication is not limited to Ethernet. The communication protocol may be CAN (Controller Area Network), CAN-FD (Controller Are Network with Flexible Data rate), LIN (Local Interconnect Network), or FlexRay, for example.

The on-board apparatus 1 includes a processing unit 3 that performs processing for communication, a relay device 4, a plurality of in-vehicle communication units 5, and a wireless communication unit 6. The in-vehicle communication units 5 are input/output interfaces for communicating with the on-board devices 2. If, for example, the communication protocol is Ethernet, the in-vehicle communication units 5 each include an Ethernet PHY unit that supports TCP/IP packets, UDP/IP packets or the like. The in-vehicle communication units 5 may each include a connector connected to the on-board device 2. In the present embodiment, the on-board apparatus 1 includes three in-vehicle communication units 5. The in-vehicle communication units 5 are connected to the on-board devices 2. The in-vehicle communication units 5 are also connected to the relay device 4. Note that the in-vehicle communication units 5 may be incorporated in the relay device 4.

The relay device 4 is a layer 2 switch, for example. The relay device 4 is connected to the wireless communication unit 6. In addition, the relay device 4 is connected to the processing unit 3 by a lane 70 to be described later. The relay device 4 relays communication between each on-board device 2 or the wireless communication unit 6 and the processing unit 3. The relay device 4 outputs data output from the on-board devices 2 via the in-vehicle communication units 5, to the processing unit 3, for example. The relay device 4 also outputs data output from the wireless communication unit 6, to the processing unit 3. The relay device 4 also outputs data output from the processing unit 3, to the on-board devices 2 via the in-vehicle communication units 5.

The wireless communication unit 6 includes an out-of-vehicle communication unit (not illustrated) and an input/output I/F (not illustrated) for communicating with the relay device 4. The out-of-vehicle communication unit is a communication apparatus for performing wireless communication using a mobile communication protocol such as 4G, LTE (Long Term Evolution/registered trademark), 5G, or WiFi. The wireless communication unit 6 transmits/receives data to/from, for example, an external server (not illustrated) provided outside the vehicle C, via an antenna 6a connected to the out-of-vehicle communication unit. Communication between the wireless communication unit 6 and the external server is performed via an external network such as a public network or the Internet. The wireless communication unit 6 may communicate with a mobile terminal such as a smartphone held by an occupant of the vehicle C, via the antenna 6a. The input/output I/F is a communication interface for performing, for example, serial communication with the relay device 4. The on-board apparatus 1 and the wireless communication unit 6 may be mounted in the vehicle C as separate apparatuses, for example. In this case, the on-board apparatus 1 and the wireless communication unit 6 are communicably connected to each other.

The processing unit 3 is a processor such as a microcomputer, or an SoC (System on Chip). The processing unit 3 also functions as a layer 3 switch. The processing unit 3 includes a control unit 30, a storage unit 31, and a temperature detection unit 32. The control unit 30 is connected to the storage unit 31 and the temperature detection unit 32. The control unit 30 is constituted by a CPU (Central Processing Unit), an MPU (Micro Processing Unit), or the like, and performs various types of control processing, computation processing, and the like by reading out and executing a program 310 and data stored in the storage unit 31 in advance. The control unit 30 communicates with the relay device 4, for example. The control unit 30 also communicates with the on-board devices 2 via the relay device 4. In addition, the control unit 30 communicates with an external server via the relay device 4 and the wireless communication unit 6. The control unit 30 is not limited only to a software processing unit that performs software processing such as a CPU, and may include a hardware processing unit that performs various control processing, computation processing, and the like through hardware processing of an FPGA, an ASIC, or an SoC.

The storage unit 31 is constituted by a volatile memory element such as a RAM (Random Access Memory) or a non-volatile memory element such as a ROM (Read Only Memory), an EEPROM (Electrically Erasable Programmable ROM), or a flash memory. The program 310 and data that is referred to during processing are stored in the storage unit 31 in advance. The program 310 may be read out from a recording medium 311 readable by the processing unit 3 and stored in the storage unit 31. In addition, the program 310 may be downloaded from an external computer (not illustrated) connected to a communication network (not illustrated), and stored in the storage unit 31.

The temperature detection unit 32 is a thermistor, for example. The temperature detection unit 32 detects the temperature of the on-board apparatus 1 that includes the temperature in the processing unit 3 or the temperature of a region near the processing unit 3. The control unit 30 obtains the temperature of the on-board apparatus 1 detected by the temperature detection unit 32.

The processing unit 3 and the relay device 4 are connected to each other by the lane 70. The lane 70 is a communication line that is used for communication that supports the PCI Express (hereinafter, PCIe) standard. One lane 70 is made of two wirings. The lane 70 is equivalent to a communication line. In FIG. 1, the processing unit 3 and the relay device 4 are connected to each other by two lanes 70. In the present embodiment, an example will be described in which the processing unit 3 and the relay device 4 perform communication using one lane 70.

In the PCIe standard, standards that includes Gen1, Gen2, and Gen3 are stipulated in accordance with a bandwidth that is used for communication. Gen1 is a standard that uses a bandwidth in which a communication speed for each lane 70 is 2.5 Gbps (Giga bits per second). Gen2 is a standard that uses a bandwidth in which a communication speed for each lane 70 is 5 Gbps. Gen2 is a standard of a generation higher than Gen1 by one generation. Gen3 is a standard that uses a bandwidth in which a communication speed for each lane 70 is 8 Gbps. Gen3 is a standard that is one generation higher than Gen2. Note that a standard of a generation that is higher than Gen3 may also be used. Hereinafter, a communication speed of 2.5 Gbps is also referred to as a communication speed of Gen1. A communication speed of 5 Gbps is also referred to as a communication speed of Gen2. Furthermore, a communication speed of 8 Gbps is also referred to as a communication speed of Gen3.

On the lanes 70, it is possible to switch between a communication speed of a generation that supports PCIe and a communication speed of a generation lower than this generation, by switching between a bandwidth for the generation that supports PCIe and a bandwidth of the generation lower than this generation. In the present embodiment, an example will be described in which the lanes 70 supports the PCIe standard of Gen3. On the lanes 70 of Gen3, it is possible to switch between the communication speed of Gen3, the communication speed of Gen2, and the communication speed of Gen1, by switching between the bandwidth of Gen3, the bandwidth of Gen2, and the bandwidth of Gen1. In other words, the lanes 70 are compatible with lower generations.

The control unit 30 sets a communication speed of each lane 70 by increasing/decreasing the bandwidth that is used for communication on the lane 70, and communicates with the relay device 4 at the set communication speed, for example. In other words, the control unit 30 controls the communication speed of communication that is performed via the lane 70, by increasing/decreasing the bandwidth that is used for communication on the lane 70. When, for example, the control unit 30 changes the communication speed on the lane 70, the relay device 4 follows the control unit 30 and changes the communication speed, and communicates with the control unit 30 at the changed communication speed. The control unit 30 may notify the relay device 4 of the changed communication speed when changing the communication speed, for example. In the present embodiment, the processing unit 3 and the relay device 4 perform communication using one lane 70, and thus the communication speed on the one lane 70 is a communication speed of communication between the processing unit 3 and the relay device 4. Communication between the processing unit 3 and the relay device 4 is included in communication that is performed via the communication line.

An example will be described below in which the control unit 30 controls a communication speed. The control unit 30 detects a communication load on a lane 70, using a known technique. QoS (Quality of Service) is used for detection of a communication load, for example. The communication load is expressed as the number of bits of data transmitted/received via the lane 70 per unit time, for example. The unit for the communication load in this case is Gbps, for example. The control unit 30 changes the communication speed on the lane 70 to the communication speed of Gen1, the communication speed of Gen2, or the communication speed of Gen3, in accordance with the detected communication load, and communicates with the relay device 4 via the lane 70. In other words, the control unit 30 controls the communication speed on the lane 70 based on the detected communication load.

When, for example, an IG (ignition) switch (not illustrated) changes from an off-state to an on-state, the control unit 30 sets the communication speed on the lane 70 to 2.5 Gbps, and performs communication with the relay device 4. That is to say, the control unit 30 sets the communication speed on the lane 70 to the communication speed of Gen1, and communicates with the relay device 4.

The control unit 30 detects the communication load on the lane 70, and determines whether or not the detected communication load is larger than or equal to a first threshold value, for example, 2.25 Gbps. If the communication load is smaller than the first threshold value, the control unit 30 does not change the communication speed on the lane 70. In other words, the control unit 30 communicates with the relay device 4 in a state where the communication speed on the lane 70 is 2.5 Gbps.

If the communication load is larger than or equal to the first threshold value, the control unit 30 determines whether or not the detected communication load is larger than or equal to a second threshold value. The second threshold value is larger than the first threshold value. The second threshold value is 4.5 Gbps, for example. If the communication load is smaller than the second threshold value, the control unit 30 sets the communication speed on the lane 70 to 5 Gbps, and communicates with the relay device 4. That is to say, the control unit 30 sets the communication speed on the lane 70 to the communication speed of Gen2, and communicates with the relay device 4.

If the communication load is larger than or equal to the second threshold value, the control unit 30 sets the communication speed on the lane 70 to 8 Gbps, and performs communication with the relay device 4. That is to say the control unit 30 sets the communication speed on the lane 70 to the communication speed of Gen3, and performs communication with the relay device 4.

If, for example, the communication speed on the lane 70 is set to the communication speed of Gen3, and the communication load is smaller than the second threshold value, the control unit 30 sets the communication speed on the lane 70 to the communication speed of Gen2. Also, if the communication speed on the lane 70 is set to the communication speed of Gen2, and the communication load is smaller than the first threshold value, the control unit 30 sets the communication speed on the lane 70 to the communication speed of Gen1. If, for example, the communication speed on the lane 70 is set to the communication speed of Gen3 and the communication load is smaller than the first threshold value, the control unit 30 may set the communication speed on the lane 70 to the communication speed of Gen1.

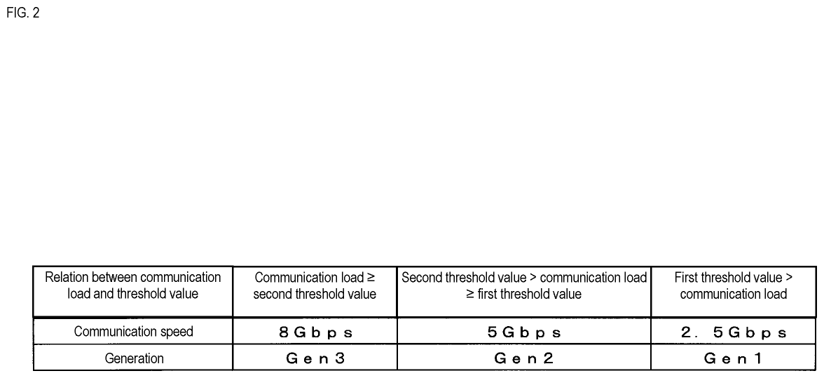

FIG. 2 is a diagram for describing the relation between a communication load-threshold value relation, communication speed, and generation of standard. If the communication load is smaller than the first threshold value, the communication speed is set to 2.5 Gbps. That is to say, the communication speed is set to the communication speed of Gen1. If the communication load is larger than or equal to the first threshold value, and is smaller than the second threshold value, the communication speed is set to 5 Gbps. That is to say, the communication speed is set to the communication speed of Gen2. If the communication load is larger than or equal to the second threshold value, the communication speed is set to 8 Gbps. That is to say, the communication speed is set to the communication speed of Gen3.

In the above example, the value of 90% of the communication speed of Gen1 is used as the first threshold value, but it suffices for the first threshold value to be smaller than or equal to the communication speed of Gen1, and there is no limitation to the above example. Also, the value of 90% of the communication speed of Gen2 is used as the second threshold value, but it suffices for the second threshold value to be larger than the first threshold value and smaller than or equal to the communication speed of Gen2, and there is no limitation to the above example.

When the IG switch is changed from the off-state to the on-state, the control unit 30 may set the communication speed on the lane 70 to a communication speed other than 2.5 Gbps, for example, 5 or 8 Gbps, and communicate with the relay device 4.

In the present embodiment, the control unit 30 controls the communication speed on the lane 70 by setting the communication speed on the lane 70 to the communication speed of Gen1, the communication speed of Gen2, or the communication speed of Gen3, but control of the communication speed is not limited to the above example. The control unit 30 may increase or decrease the communication speed by a predetermined speed, for example, in steps of 1 Gbps in accordance with a communication load.

In the present embodiment, the lane 70 for which the communication speed can be changed to three communication speeds, namely the communication speed of Gen1, the communication speed of Gen2, and the communication speed of Gen3 is used, but the lane 70 is not limited to the above example. A lane 70 for which the communication speed can be changed to two communication speeds, namely the communication speed of Gen1 and the communication speed of Gen2 may be used, for example. A lane 70 for which the communication speed can also be changed to a communication speed for a generation higher than Gen3, for example, Gen4 may also be used.

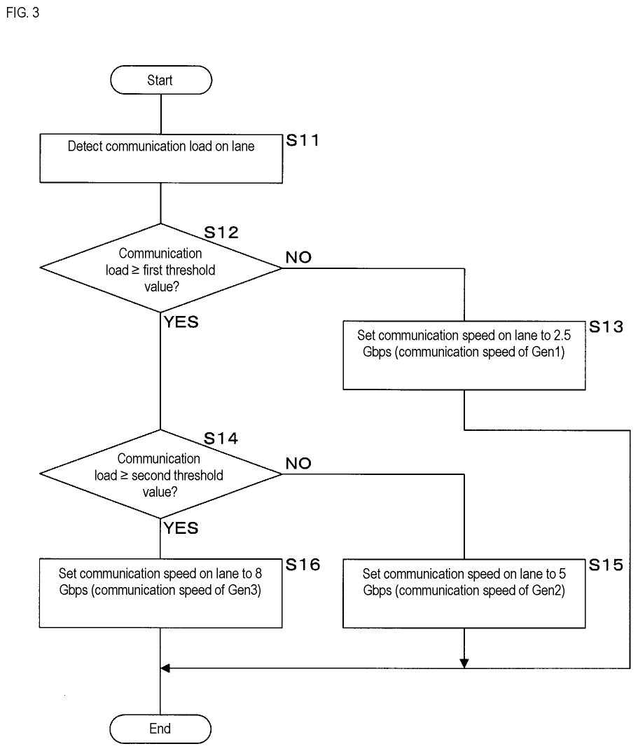

FIG. 3 is a flowchart illustrating processing that is performed by the control unit 30 of the processing unit 3. When, for example, the IG switch is changed from the off-state to the on-state, the control unit 30 of the processing unit 3 starts the following processing. When the IG switch is in the on-state, the control unit 30 may regularly perform the following processing. Hereinafter, “step” is abbreviated as “S”.

The control unit 30 detects a communication load on the lane 70 as described above (S11). The control unit 30 determines whether or not the detected communication load is larger than or equal to a first threshold value (S12). If the communication load is not larger than or equal to the first threshold value (S12: NO), in other words, if the communication load is smaller than the first threshold value, the control unit 30 sets the communication speed on the lane 70 to 2.5 Gbps (S13), and communicates with the relay device 4. In other words, the control unit 30 sets the communication speed on the lane 70 to the communication speed of Gen1, and communicates with the relay device 4. The control unit 30 ends the procedure. The control unit 30 may perform the processing of S11 instead of ending the procedure.

If the communication load is larger than or equal to the first threshold value (S12: YES), the control unit 30 determines whether or not the detected communication load is larger than or equal to the second threshold value (S14). If the communication load is not larger than or equal to the second threshold value (S14: NO), in other words, if the communication load is smaller than the second threshold value, the control unit 30 sets the communication speed on the lane 70 to 5 Gbps (S15), and communicates with the relay device 4. In other words, the control unit 30 sets the communication speed on the lane 70 to the communication speed of Gen2, and communicates with the relay device 4. The control unit 30 ends the procedure. The control unit 30 may perform the processing of S11 instead of ending the procedure.

If the communication load is larger than or equal to the second threshold value (S14: YES), the control unit 30 sets the communication speed on the lane 70 to 8 Gbps (S16), and communicates with the relay device 4. In other words, the control unit 30 sets the communication speed on the lane 70 to the communication speed of Gen3, and communicates with the relay device 4. The control unit 30 ends the procedure. The control unit 30 may perform the processing of S11 instead of ending the procedure.

In the present embodiment, the control unit 30 communicates with the on-board devices 2 via a lane 70 and the relay device 4. The control unit 30 detects the communication load on the lane 70, and controls the communication speed of communication that is performed via the lane 70, based on the detected communication load. If the communication load is larger than or equal to a fixed value, and, for example, the communication amount is large, the control unit increases the communication speed. If the communication load is smaller than the fixed value, and, for example, the communication amount is small, the control unit decreases the communication speed. The fixed value may include a first threshold value and a second threshold value. Generally, power consumption when the communication speed is high is large. Power consumption when the communication speed is low is small. Communication is performed at a communication speed that is based on a communication load, and thus it is possible to suppress an increase in the power consumption of the on-board apparatus 1. The control unit 30 increases the communication speed when the communication load increases, and decreases the communication speed when the communication load decreases, and thus it is possible to efficiently control the communication speed in accordance with the communication load.

The processing unit 3 and the relay device 4 perform communication that supports the PCIe standard, via a lane 70. For the lane 70, a communication speed that is based on a bandwidth that is used for communication is stipulated. The control unit 30 controls the communication speed by increasing/decreasing the bandwidth that is used for communication, and thus the communication speed on the lane 70 is easily changed.

The bandwidth that is used for communication on the lane 70 includes bandwidths of a plurality of generations that are compatible based on a communication standard. The bandwidths of the plurality of generations include a bandwidth of Gen1, a bandwidth of Gen2, and a bandwidth of Gen3. It is possible to switch to a bandwidth of an appropriate generation that is based on a communication load and efficiently control the communication speed, using the above compatibility (downward compatibility) of the standard between generations, on the lane 70.

In the present embodiment, the processing unit 3 and the relay device 4 are connected to each other by two lanes 70, but the processing unit 3 and the relay device 4 may also be connected to each other by one lane 70 or three or more lanes 70.

The on-board apparatus 1 may also be an integrated ECU that includes a plurality of ports. The integrated ECU is a central control apparatus such as vehicle computer. The integrated ECU communicates with the on-board devices 2, and performs processing for controlling the on-board devices 2. The integrated ECU also functions as a relay apparatus such as a gateway or an Etherswitch that relays communication between a plurality of on-board devices 2.

### Second Embodiment

Constituent elements in a configuration in a second embodiment that are similar to those in the first embodiment are given the same reference numerals, and a detailed description thereof is omitted. The second embodiment is directed to an on-board apparatus 1 that performs communication using a plurality of lanes 70.

In the on-board apparatus 1 according to the second embodiment, the processing unit 3 is connected to the relay device 4 by two lanes 70 similarly to the first embodiment. The control unit 30 of the processing unit 3 communicates with the relay device 4 via at least one of the two lanes 70. The total of communication speeds on the two lanes 70 is the communication speed of communication between the processing unit 3 and the relay device 4. The communication speeds on the two lanes 70 can be changed similarly to the lanes 70 according to the first embodiment.

Two lanes 70 can be used for communication, and thus the communication speed of communication between the processing unit 3 and the relay device 4 can be changed in accordance with a combination of communication speeds on the two lanes 70. When, for example, the communication speed on each of the lanes 70 is 8 Gbps, the communication speed of communication between the processing unit 3 and the relay device 4 is 16 Gbps. When a lane 70 for which the communication speed is 2.5 Gbps and a lane 70 for which the communication speed is 5 Gbps are used, the communication speed of communication between the processing unit 3 and the relay device 4 is 7.5 Gbps. Hereinafter, the communication speed of communication between the processing unit 3 and the relay device 4 is also referred to as a “communication speed between the processing unit 3 and the relay device 4”.

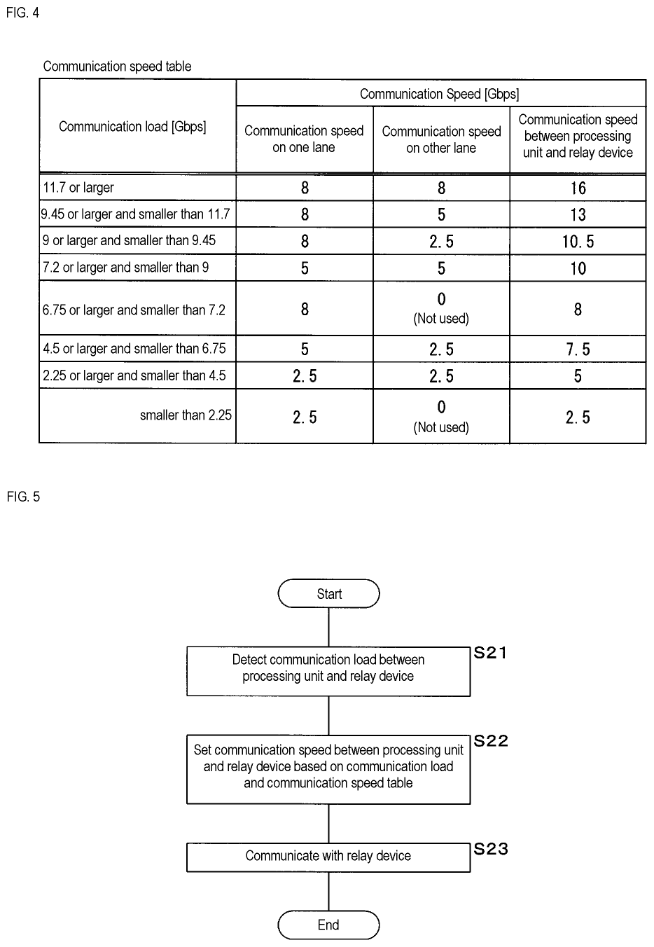

The storage unit 31 of the processing unit 3 according to the second embodiment stores a communication speed table in which communication loads and communication speeds between the processing unit 3 and the relay device 4 are stored in association with each other. FIG. 4 is a conceptual diagram showing a content example of the communication speed table. The communication speed table in FIG. 4 includes a communication load column and a communication speed column. The communication speed column includes a communication speed column for one of the two lanes 70 and a communication speed column for the other lane 70. The communication speed column also includes a communication speed column for communication speed between the processing unit 3 and the relay device 4.

The communication speed column for the one lane 70 stores communication speeds on the one lane 70 out of the two lanes 70. In FIG. 4, the communication speed column for the one lane 70 stores 8 Gbps, 5 Gbps, or 2.5 Gbps as a communication speed on the one lane 70. The communication speed column for the other lane 70 stores communication speeds on the other lane 70 out of the two lanes 70. In FIG. 4, the communication speed column for the other lane 70 stores 8 Gbps, 5 Gbps, 2.5 Gbps, or 0 Gbps as a communication speed on the other lane 70. The communication speed of 0 Gbps indicates that the other lane 70 is not used for communication.

The communication speed column for communication between the processing unit 3 and the relay device 4 stores communication speeds between the processing unit 3 and the relay device 4 that are based on a combination of communication speeds on the two lanes. In other words, the communication speed column for communication between the processing unit 3 and the relay device 4 stores the sum of a communication speed on the one lane 70 and a communication speed on the other lane 70.

The communication load column stores a plurality of ranges of communication load. Each range of communication load is associated with a communication speed between the processing unit 3 and the relay device 4. In FIG. 4, a range of communication load smaller than 2.25 Gbps is associated with a communication speed of 2.5 Gbps between the processing unit 3 and the relay device 4. A range of communication load larger than or equal to 2.25 Gbps and smaller than 4.5 Gbps is associated with a communication speed of 5 Gbps between the processing unit 3 and the relay device 4. A range of communication load larger than or equal to 4.5 Gbps and smaller than 6.75 Gbps is associated with a communication speed of 7.5 Gbps between the processing unit 3 and the relay device 4. A range of communication load larger than or equal to 6.75 Gbps and smaller than 7.2 Gbps is associated with a communication speed of 8 Gbps between the processing unit 3 and the relay device 4. A range of communication load larger than or equal to 7.2 Gbps and smaller than 9 Gbps is associated with a communication speed of 10 Gbps between the processing unit 3 and the relay device 4. A range of communication load larger than or equal to 9 Gbps and smaller than 9.45 Gbps is associated with a communication speed of 10.5 Gbps between the processing unit 3 and the relay device 4. A range of communication load larger than or equal to 9.45 Gbps and smaller than 11.7 Gbps is associated with a communication speed of 13 Gbps between the processing unit 3 and the relay device 4. A range of communication load larger than or equal to 11.7 Gbps is associated with a communication speed of 16 Gbps between the processing unit 3 and the relay device 4.

In the present embodiment, the ranges of communication load are set using, as references, the values of 90% of communication speeds between the processing unit 3 and the relay device 4. 2.25 Gbps is the value of 90% of 2.5 Gbps, for example. 4.5 Gbps is the value of 90% of 5 Gbps. Ranges of communication load are not limited to the above example. Ranges of communication load may be set using, as references, the values of 80% or 95% of communication speeds between the processing unit 3 and the relay device 4, for example.

The control unit 30 of the processing unit 3 detects communication loads on the two lanes 70, similarly to the first embodiment. The control unit 30 controls the communication speed between the processing unit 3 and the relay device 4 based on the total of the detected communication loads on the two lanes 70 and the communication speed table. Hereinafter, the total of communication loads on the two lanes 70 is also referred to as a “communication load between the processing unit 3 and the relay device 4”.

An example will be described below in which the control unit 30 controls the communication speed between the processing unit 3 and the relay device 4. The control unit 30 detects the communication load between the processing unit 3 and the relay device 4. The control unit 30 controls the communication speed between the processing unit 3 and the relay device 4 by referring to the communication speed table, and communicates with the relay device 4. If, for example, the detected communication load is 12 Gbps, the control unit 30 sets the communication speed between the processing unit 3 and the relay device 4 to 16 Gbps by setting the communication speed on each of the two lanes 70 to 8 Gbps, and communicates with the relay device 4.

If, for example, the detected communication load is 10 Gbps, the control unit 30 sets the communication speed on the one lane 70 to 8 Gbps, and sets the communication speed on the other lane 70 to 5 Gbps. The communication speed between the processing unit 3 and the relay device 4 is set to 13 Gbps. The control unit 30 communicates with the relay device 4 in a state where the communication speed between the processing unit 3 and the relay device 4 is set to 13 Gbps.

If, for example, the detected communication load is 7 Gbps, the control unit 30 sets the communication speed on the one lane 70 to 8 Gbps, and communicates with the relay device 4 via the one lane 70. The other lane 70 is not used for communication with the relay device 4. At this time, the communication speed between the processing unit 3 and the relay device 4 is set to 8 Gbps.

In the example in FIG. 4, when communication is performed between the processing unit 3 and the relay device 4 at a communication speed of 5 Gbps, the control unit 30 sets each of the communication speeds on the two lanes 70 to 2.5 Gbps. When, for example, communication is performed between the processing unit 3 and the relay device 4 at a communication speed of 5 Gbps, the control unit 30 may set the communication speed on the one lane 70 out of the two lanes 70 to 5 Gbps, and communicate with the relay device 4 via the one lane 70 without using the other lane 70.

As described above, the control unit 30 controls the communication speed between the processing unit 3 and the relay device 4 by increasing/decreasing at least one of a bandwidth of a lane 70 used for communication and the number of lanes 70, based on the communication speed table and a detected communication load. A method in which the control unit 30 controls the communication speed is not limited to a method that is based on the communication speed table. A plurality of threshold values related to communication loads may be stored in the storage unit 31 in advance, for example. The control unit 30 compares a detected communication load with a threshold value related to the communication load, increases/decreases at least one of a bandwidth of a lane 70 and the number of lanes 70 based on the comparison result, and controls the communication speed between the processing unit 3 and the relay device 4.

FIG. 5 is a flowchart illustrating the processing that is performed by the control unit 30 according to the second embodiment. When, for example, the IG switch is changed from the off-state to the on-state, the control unit 30 starts the following processing. When the IG switch is in the on-state, the control unit 30 may regularly perform the following processing.

The control unit 30 detects a communication load between the processing unit 3 and the relay device 4 (S21). The control unit 30 sets a communication speed between the processing unit 3 and the relay device 4 based on the detected communication load and the communication speed table (S22). The control unit 30 communicates with the relay device 4 (S23), and ends the procedure. The control unit 30 may perform the processing of S21 instead of ending the procedure.

In the present embodiment, the control unit 30 can communicate with the on-board devices 2 via a plurality of lanes 70 and the relay device 4. The control unit 30 controls the communication speed between the processing unit 3 and the relay device 4 by increasing/decreasing at least one of a bandwidth of a lane 70 and the number of lanes 70. The control unit 30 can perform communication at a higher communication speed by using a plurality of lanes 70, than in a case of using one lane 70. The control unit 30 can set the various communication speeds using a combination of a plurality of lanes 70 and bandwidths of the lanes 70. Note that the on-board apparatus 1 may be configured to control the communication speed between the processing unit 3 and the relay device 4 by the control unit 30 increasing/decreasing only the number of lanes 70, out of a bandwidth of a lane 70 and the number of lanes 70.

The communication speed table stores a plurality of communication loads and a plurality of communication speeds in association with each other. The control unit 30 controls the communication speed based on the communication speed table and the detected communication load, and thus, even if a plurality of communication speeds can be selected, it is possible to appropriately set a communication speed that is based on the communication load.

In the present embodiment, the processing unit 3 and the relay device 4 perform communication via two lanes, but the number of lanes 70 is not limited to two. The processing unit 3 and the relay device 4 may perform communication via three or more lanes 70, for example.

### Third Embodiment

Constituent elements in a configuration in a third embodiment that are similar to those in the first embodiment are given the same reference numerals, and a detailed description thereof is omitted. The third embodiment is directed to an on-board apparatus 1 that controls a communication speed based on the temperature of the on-board apparatus 1.

An example will be described below in which the processing unit 3 and the relay device 4 perform communication using one lane 70 similarly to the first embodiment. The processing unit 3 of the on-board apparatus 1 according to the third embodiment includes the temperature detection unit 32 similarly to the first embodiment. The temperature detection unit 32 detects the temperature of the on-board apparatus 1, including the temperature in the processing unit 3 or the temperature of a region near the processing unit 3. The control unit 30 obtains the temperature of the on-board apparatus 1 detected by the temperature detection unit 32. In the present embodiment, the temperature detection unit 32 is incorporated in the processing unit 3, but the temperature detection unit 32 does not need to be incorporated in the processing unit 3. The temperature detection unit 32 may be provided outside the processing unit 3.

Similarly to the first embodiment, the control unit 30 detects a communication load on the lane 70, and controls the communication speed on the lane 70 based on the detected communication load. Furthermore, the control unit 30 controls the communication speed on the lane 70 based on the temperature of the on-board apparatus 1 obtained from the temperature detection unit 32.

Control of a communication speed that is based on the temperature of the on-board apparatus 1 will be described below. As described above, the control unit 30 obtains the temperature of the on-board apparatus 1 from the temperature detection unit 32. The control unit 30 determines whether or not the obtained temperature of the on-board apparatus 1 is higher than or equal to a predetermined temperature. The predetermined temperature is stored in the storage unit 31 in advance, for example. The predetermined temperature is 60° C., for example, but there is no limitation thereto.

If the temperature of the on-board apparatus 1 is higher than or equal to the predetermined temperature, the control unit 30 decreases the communication speed between the processing unit 3 and the relay device 4 as follows. The control unit 30 decreases the communication speed between the processing unit 3 and the relay device 4 by changing the communication speed on the lane 70 to a communication speed of a lower generation, for example. When the communication speed on the lane 70 that is used for communication is the communication speed of Gen2, the control unit 30 changes the above communication speed on the lane 70 from the communication speed of Gen2 to the communication speed of Gen1. The communication speed between the processing unit 3 and the relay device 4 decreases. When the communication speed on the lane 70 that is used for communication is the communication speed of Gen3, the control unit 30 changes the above communication speed on the lane 70 from the communication speed of Gen3 to the communication speed of Gen2. The communication speed between the processing unit 3 and the relay device 4 decreases.

Note that, when the communication speed on the lane 70 that is used for communication is the communication speed of Gen3, the control unit 30 may change the above communication speed on the lane 70 from the communication speed of Gen3 to the communication speed of Gen1. Control of the communication speed that is based on the temperature of the on-board apparatus 1 is not limited to the above example. The control unit 30 may decrease the communication speed on the lane 70 by a predetermined value, for example, 1 Gbps.

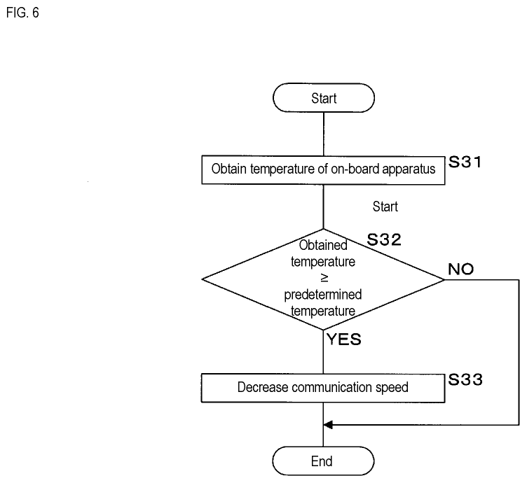

FIG. 6 is a flowchart illustrating processing that is performed by the control unit 30 according to the third embodiment. When, for example, the IG switch is changed from the off-state to the on-state, the control unit 30 starts the following processing. When the IG switch is in the on-state, the control unit 30 may regularly perform the following processing.

The control unit 30 obtains the temperature of the on-board apparatus 1 from the temperature detection unit 32 as described above (S31). The control unit 30 determines whether or not the obtained temperature is higher than or equal to a predetermined temperature (S32). If the obtained temperature is not higher than or equal to the predetermined temperature (S32: NO), that is to say if the obtained temperature is lower than the predetermined temperature, the control unit 30 ends the procedure. The control unit 30 may perform the processing of S31 instead of ending the procedure.

If the obtained temperature is higher than or equal to the predetermined temperature (S32: YES), the control unit 30 decreases the communication speed as described above (S33), and ends the procedure. The control unit 30 changes the communication speed on the lane 70 from the communication speed of Gen3 to the communication speed of Gen2, or from the communication speed of Gen2 to the communication speed of Gen1, for example. The control unit 30 may perform the processing of S31 instead of ending the procedure.

The on-board apparatus 1 generates heat when performing processing such as communication. Generally an amount of heat generated by the on-board apparatus 1 when the communication speed is high is larger than in a case where the communication speed is low. If the temperature of the on-board apparatus 1 is higher than or equal to the predetermined temperature, the on-board apparatus 1 decreases the communication speed, and thus the amount of heat generated by the on-board apparatus 1 decreases compared with the amount of heat generated before the communication speed was decreased. Therefore, it is possible to suppress an increase in the amount of heat generation. An increase in the amount of heat generation is suppressed, and thus the on-board apparatus 1 can prevent the temperature of the on-board apparatus 1 from becoming too high. Since the temperature of the on-board apparatus 1 does not become too high, it is possible to prevent the on-board apparatus 1 from malfunctioning due to a high temperature. When the temperature of the on-board apparatus 1 is too high, there is a risk that the on-board apparatus 1 cannot appropriately perform processing such as communication.

Preferably, control of a communication speed that is based on a temperature is prioritized to control of a communication speed that is based on a communication load. The control unit 30 does not control a communication speed based on a communication load for a certain period of time after the communication speed is changed based on the temperature of the on-board apparatus 1, for example. The certain period of time is stored in the storage unit 31, for example. Since control of a communication speed that is based on the temperature of the on-board apparatus 1 is prioritized, it is possible to more appropriately prevent the temperature of the on-board apparatus 1 from becoming too high.

Note that the processing unit 3 and the relay device 4 may perform communication with each other using a plurality of lanes 70. In this case, similarly to the second embodiment, the control unit 30 increase/decreases at least one of bandwidths of lanes 70 that are used for communication and the number of such lanes 70 based on the communication load between the processing unit 3 and the relay device 4, and controls the communication speed between the processing unit 3 and the relay device 4. Furthermore, the control unit 30 obtains the temperature of the on-board apparatus 1, and controls the communication speed between the processing unit 3 and the relay device 4 based on the obtained temperature of the on-board apparatus 1. If, for example, the temperature of the on-board apparatus 1 is higher than or equal to a predetermined temperature, the control unit 30 decreases at least one of bandwidths of the lanes 70 that are used for communication and the number of such lanes 70, and decreases the communication speed between the processing unit 3 and the relay device 4. Also in the case where the processing unit 3 and the relay device 4 perform communication using a plurality of lanes 70, control of a communication speed that is based on a temperature is preferably prioritized to control of a communication speed that is based on a communication load.

### Fourth Embodiment

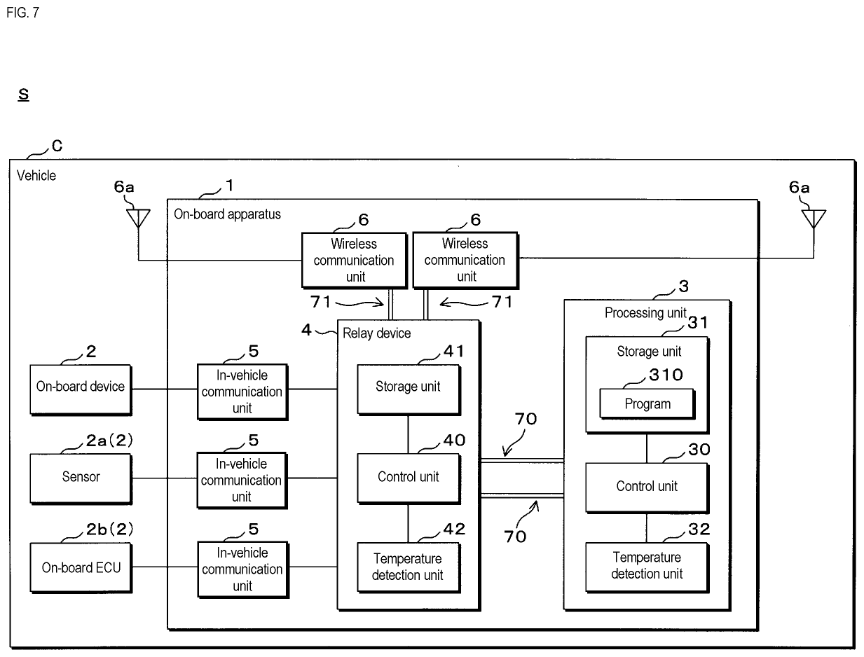

FIG. 7 is a schematic diagram illustrating a configuration of an on-board system S according to a fourth embodiment. Constituent elements in a configuration in the fourth embodiment that are similar to those in the first embodiment are given the same reference numerals, and a detailed description thereof is omitted. The fourth embodiment is directed to the on-board apparatus 1 in which the relay device 4, in addition to the processing unit 3, controls a communication speed.

The on-board system S according to the fourth embodiment includes the on-board apparatus 1 that is mounted in the vehicle C similarly to the on-board system S according to the first embodiment. The on-board apparatus 1 is connected to the on-board devices 2 that are mounted in the vehicle C. The on-board apparatus 1 includes the processing unit 3, the relay device 4, a plurality of in-vehicle communication units 5, and a plurality of wireless communication units 6.

The processing unit 3 and the relay device 4 are connected to each other by the two lanes 70 similarly to the first embodiment. The control unit 30 of the processing unit 3 controls the communication speeds on the lanes 70 similarly to the first, second, or third embodiment. In other words, the control unit 30 controls the communication speed between the processing unit 3 and the relay device 4.

Two wireless communication units 6 are mounted in the vehicle C according to the fourth embodiment. One of the wireless communication units 6 is a communication apparatus for performing broadband wireless communication using a communication protocol of LTE, 4G, or 5G, for example. The other wireless communication unit 6 is a communication apparatus for performing narrowband wireless communication using a communication protocol of WiFi or the like, for example.

The wireless communication units 6 are connected to the relay device 4 by lanes 71. The lanes 71 are similar to the lanes 70, and thus a detailed description thereof is omitted. In FIG. 7, the relay device 4 is connected to two lanes 71. One of the lanes 71 connects the relay device 4 and one of the wireless communication units 6 to each other. The other lane 71 connects the relay device 4 and the other wireless communication unit 6 to each other.

The relay device 4 according to the fourth embodiment includes a control unit 40, a storage unit 41, and a temperature detection unit 42. The control unit 40, the storage unit 41, and the temperature detection unit 42 are connected to each other. The control unit 40 is constituted by a CPU or an MPU, and performs various types of control processing, computation processing, and the like by reading out and executing a control program and data stored in the storage unit 41 in advance. The control unit 40 communicates with the wireless communication units 6 via the lanes 71. The control unit 40 also communicates with the processing unit 3 via the lanes 70. The control unit 40 also communicates with the on-board devices 2. The control unit 40 communicates with an external server via the lanes 71 and the wireless communication units 6, and obtains an update program from the external server, for example. The control unit 40 transmits the obtained update program to the processing unit 3 or the on-board devices 2. The control unit 40 is not limited only to a software processing unit that performs software processing, such as a CPU, and may include a hardware processing unit that performs various control processing, computation processing, and the like through hardware processing, such as an FPGA, an ASIC, or an SOC.

The storage unit 41 is constituted by a volatile memory element such as a RAM, or a non-volatile memory element such as a ROM, an EEPROM, or a flash memory. A control program and data that is referred to during processing are stored in the storage unit 41 in advance. The control program may be read out from a recording medium readable by the relay device 4, and stored in the storage unit 41. In addition, the control program may be downloaded from an external computer (not illustrated) connected to a communication network (not illustrated), and stored in the storage unit 41.

The temperature detection unit 42 is a thermistor, for example. The temperature detection unit 42 detects the temperature in the relay device 4 or the temperature of a region near the relay device 4. The temperature of the on-board apparatus 1 includes the temperature in the relay device 4 or the temperature of a region near the relay device 4. The control unit 40 obtains the temperature of the on-board apparatus 1 detected by the temperature detection unit 42.

The control unit 40 of the relay device 4 detects the communication loads on the lanes 71, and controls the communication speeds on the lanes 71 based on the detected communication loads. QoS is used for detection of communication loads that is performed by the control unit 40 of the relay device 4, similarly to detection of communication loads that is performed by the control unit 30 of the processing unit 3, for example. A method in which the control unit 40 of the relay device 4 controls the communication speeds on the lanes 71 based on communication loads is similar to a method in which the control unit 30 of the processing unit 3 controls the communication speeds on the lanes 70 based on communication loads, and thus a detailed description thereof is omitted. When, for example, the control unit 40 changes the communication speeds on the lanes 71, the wireless communication units 6 change the communication speeds following the control unit 40, and communicate with the control unit 40 at the changed communication speeds. The control unit 40 may notify the relay device 4 of the changed communication speed when changing the communication speed, for example.

The control unit 40 obtains the temperature of the on-board apparatus 1 from the temperature detection unit 42 as described above. If the temperature of the on-board apparatus 1 obtained from the temperature detection unit 42 is higher than or equal to a predetermined temperature, the control unit 40 decreases the communication speeds on the lanes 71. In other words, the control unit 40 controls the communication speeds on the lanes 71 based on the temperature of the on-board apparatus 1 obtained from the temperature detection unit 42. A method in which the control unit 40 controls the communication speeds on the lanes 71 based on the temperature of the on-board apparatus 1 is similar to a method in which the control unit 30 according to the third embodiment controls the communication speeds on the lanes 71 based on the temperature of the on-board apparatus 1, and thus a detailed description thereof is omitted. Control of the communication speeds on the lanes 71 that is based on the temperature of the on-board apparatus 1 is prioritized to control of the communication speeds on the lanes 71 that is based on the communication loads, for example. Note that the predetermined temperature that is used for control of a communication speed that is performed by the control unit 30 of the processing unit 3 based on the temperature of the on-board apparatus 1 and the predetermined temperature that is used for control of a communication speed that is performed by the control unit 40 of the relay device 4 based on the temperature of the on-board apparatus 1 may be the same temperature, or may be different temperatures.

In the present embodiment, the two wireless communication units 6 are mounted in the vehicle C, but the number of wireless communication units 6 that are mounted in the vehicle C is not limited to two. The number of wireless communication units 6 may be one, or may be three or more. The relay device 4 and one wireless communication unit 6 may be connected to each other by a plurality of lanes 71. The control unit 40 controls a communication speed based on a communication load and the communication speed table, similarly to the control unit 30 according to the second embodiment, for example.

In the present embodiment, the control unit 30 of the processing unit 3 communicates with the on-board devices 2 via the lanes 70 and the relay device 4. The control unit 30 controls the communication speed between the processing unit 3 and the relay device 4 based on the communication loads on the lanes 70. Each lane 70 is equivalent to a first communication line. The relay device 4 is connected to the wireless communication units 6 by the lanes 71. The control unit 40 of the relay device 4 controls the communication speeds on the lanes 71 based on the communication loads on the lanes 71. Each lane 71 is equivalent to a second communication line. When a large amount of data, for example, an update program for an on-board device 2 is transmitted from a wireless communication unit 6, the relay device 4 can receive the large amount of data at a high communication speed. The communication speeds on the lanes 70 and the lanes 71 are controlled in accordance with communication loads, and thus it is possible to effectively suppress an increase in the power consumption of the on-board apparatus 1. The control unit 30 and the control unit 40 are equivalent to a control unit in claims.

If the temperature of the on-board apparatus 1 obtained from the temperature detection unit 42 is higher than or equal to a predetermined temperature, the control unit 40 of the relay device 4 decreases the communication speeds on the lanes 71, and thus it is possible to suppress an increase in the amount of heat generated by the on-board apparatus 1. If the temperature of the on-board apparatus 1 obtained from the temperature detection unit 32 is higher than or equal to the predetermined temperature, the control unit 30 of the processing unit 3 decreases the communication speeds on the lanes 70, and thus it is possible to suppress an increase in the amount of heat generated by the on-board apparatus 1. The on-board apparatus 1 decreases the communication speed on at least one of the lanes 70 and the lanes 71, based on the temperature of the on-board apparatus 1, and thus it is possible to efficiently suppress an increase in the amount of heat generation.

The on-board apparatus 1 may have a configuration in which the control unit 40 of the relay device 4 controls communication speeds on both the lanes 70 and the lanes 71, for example.

The embodiments disclosed herein are examples in all respects and should not be interpreted as limiting in any manner. The scope of the present disclosure is defined not by the foregoing meanings, but is defined by the claims and intended to include all modifications within the meaning and scope equivalent to the claims.

1. An on-board apparatus that is connected to an on-board device and communicates with the on-board device, the on-board apparatus comprising:
a control unit configured to control communication with the on-board device; and
a communication line for communicating with the on-board device,
wherein the control unit
communicates with the on-board device via the communication line,
detects a communication load on the communication line, and
controls a communication speed of communication that is performed via the communication line, based on the detected communication load.

2. The on-board apparatus according to claim 1,
wherein the control unit
increases the communication speed when the communication load increases, and
decreases the communication speed when the communication load decreases.

3. The on-board apparatus according to claim 1,
wherein the control unit controls the communication speed by increasing/decreasing a bandwidth that is used for communication on the communication line.

4. The on-board apparatus according to claim 3,
wherein the bandwidth that is used for communication on the communication line includes bandwidths of a plurality of generations that are compatible with each other based on a standard of communication, and
the control unit increases/decreases the bandwidth that is used for communication on the communication line, by switching to one bandwidth out of the bandwidths of the plurality of generations based on the detected communication load.

5. The on-board apparatus according to claim 1, further comprising:
a plurality of communication lines,
wherein the control unit controls the communication speed by increasing/decreasing the number of communication lines that are used for communication.

6. The on-board apparatus according to claim 1,
wherein the control unit
obtains a temperature of the on-board apparatus, and
decreases the communication speed if the obtained temperature is higher than or equal to a predetermined temperature.

7. The on-board apparatus according to claim 1,
wherein the control unit controls the communication speed based on the detected communication load and a communication speed table in which a plurality of communication loads and a plurality of communication speeds are stored in association with each other.

8. The on-board apparatus according to claim 1, further comprising:
a relay device that relays communication between the control unit and the on-board device,
wherein the communication line includes:
a first communication line that connects the control unit and the relay device, and
a second communication line that connects a wireless communication unit for performing wireless communication and the relay device,
the control unit
communicates with the on-board device via the first communication line and the relay device, and
controls the communication speed of communication that is performed via the first communication line, based on the communication load on the first communication line, and
the relay device
communicates with the wireless communication unit via the second communication line, and
controls the communication speed of communication that is performed via the second communication line, based on the communication load on the second communication line.

9. A method for controlling a communication speed that is performed by an on-board apparatus that is connected to an on-board device and communicates with the on-board device,
wherein the on-board apparatus
communicates with the on-board device via a communication line for communicating with the on-board device,
detects a communication load on the communication line, and
controls a communication speed based on the detected communication load.

10. A program for causing a computer that is connected to an on-board device and communicates with the on-board device to execute processing for:
communicating with the on-board device via a communication line for communicating with the on-board device,
detecting a communication load on the communication line, and
controlling a communication speed based on the detected communication load.
